(19) United States
(12) Patent Application Publication
(10) Pub. No.: US 2017/0371416 A1
(43) Pub. Date: Dec. 28, 2017

(54) HAPTIC DEVICES AND METHODS

(71) Applicant: Philip ZEITLER, Berg (DE)

(72) Inventor: Philip ZEITLER, Berg (DE)

(21) Appl. No.: 15/541,293

(22) PCT Filed: Dec. 29, 2015
(86) PCT No.: PCT/EP2015/002613

§ 371 Date: Jun. 30, 2017

(30) Foreign Application Priority Data
Dec. 30, 2014 (DE) 10 2014 019 582.1

(51) Int. Cl. G06F 3/01

(52) U.S. Cl. CPC G06F 3/016; G06F 3/014

(57) ABSTRACT

Devices and methods for providing so-called force feedback to a user, in particular in form of a data glove, and a corresponding control method.

### FIELD OF THE PRESENT INVENTION

The present invention generally relates to devices and methods for providing so-called force feedback to a user.

### BACKGROUND OF THE PRESENT INVENTION

So-called data gloves are known means for detection of stances of a human hand, positions and movements of its fingers etc., in order to control hardware and/or software thereby. This is used, for example, for the control of robots in the field of virtual reality (VR) and for the control of video games.

Data gloves are generally just input means, i.e. they are providing control signals for controlling hardware and/or software. Data gloves, which serve as output means are also known, namely those providing force feedback to a user depending on received control signals. This is used, for example, to convey to a user, who handles virtual objects in a VR environment, a sensation to the user as if the objects were real and actually touched with the user's hand.

Known approaches for data gloves with force feedback have drawbacks, inter alia with respect to the large form factors, weight and force feedback just limitedly reflecting reality.

All this also applies to devices detecting stances, positions and movements of other human body parts and providing force feedback to the human body parts, respectively. Examples therefore are suits and garments substantially constructed and operating as data gloves.

### OBJECT OF THE PRESENT INVENTION

It is an object of the present invention to provide means which overcome the drawbacks of known devices that provide force feedback to a user.

### BRIEF DESCRIPTION OF THE PRESENT INVENTION

To solve the above object, the present invention provides subject-matter according to the independent patent claims; preferred embodiments are specified in the dependent patent claims.

In particular, the present invention relates to haptic devices according to the independent device claims.

Thus, the present invention provides a haptic device for providing, to a user of the haptic device, force feedback with respect to a first joint connecting two body parts (in the following first and second body parts) and with respect to a second joint also connecting two body parts (in the following third and fourth body parts), the second joint being arranged in series with respect to the first joint.

A haptic device conveys force feedback to a user, wherein the user feels forces generated by the haptic device. This may, for example, occur by limiting or preventing movements of the user, in other words, at least by increasing the moving resistance; in such cases, one may also speak of passive haptic devices, because they do not actively generate forces, but receive forces. In addition or alternatively, the force feedback may also be caused in that a haptic device generates forces acting on the user, for example by movement of components of the haptic device. In the field of computers, such as for example VR environments, video games, simulations in the field of robotics or medicine, haptic devices are also referred to as force feedback devices.

Two joints arranged in series may, for example, be the distal- and proximal-interphalangeal joints, the distal- and metacarpo-phalangeal joints, the proximal- and metacarpo-phalangeal joints or the distal-, proximal- and metacarpo-phalangeal joints of each of a finger; or be the distal- and proximal-interphalangeal joints, the distal- and metatarso-phalangeal joints, the proximal- and metatarso-phalangeal joints or the distal-, proximal- and metatarso-phalangeal joints of each of a toe; or be the ankle- and knee joints, the ankle- and hip joints, the knee- and hip joints or the ankle-, knee- and hip joints of each of a leg; or be the wrist- and elbow joints, the wrist- and shoulder joints, the elbow- and shoulder joints or the wrist-, elbow- and shoulder joints of each of an arm; etc.

Starting therefrom, also the body parts may be considered as being arranged in series.

Depending on the joints, all four body parts may be different or, for example, the second and third body parts may be the same body part, e.g. a first finger phalanx, a second finger phalanx, a lower leg, a thigh, a forearm, an upper arm.

For illustration of possible first and fourth body parts, reference is made to a finger, wherein the corresponding observations accordingly apply mutatis mutandis to other serial joint arrangements. For a finger, the first body part may be the third finger phalanx and the fourth body part may be the first finger phalanx or the back of the hand in the region of the metacarpo-phalangeal joint of this finger, or, the first body part may be the second finger phalanx and the fourth body part may be the back of the hand in the region of the metacarpo-phalangeal joint of this finger.

The haptic device according to the invention comprises a first haptic unit and a second haptic unit.

The first haptic unit provides a haptic sensation (force feedback) with respect to the first joint, and the second haptic unit provides a haptic sensation (force feedback) with respect to the second joint.

The first haptic unit comprises a first brake, which is actuatable by means of a first control signal. The brake is provided for arrangement on the first body part, which is connected to the second body part via the first joint. The arrangement of the first brake, for example, may be made by means of a glove, on or in which the first brake is arranged.

The first haptic unit further comprises a first flexible element extending between the first body part and the second body part and extending beyond the first joint. The first flexible element has a first end adapted for attachment to a second body part and a second end in engagement with the first brake. The engagement is such that, in the case the first brake is not actuated, the second end of the first flexible element is moveable relative to the first brake. Rather, the movability of the second end of the first flexible element, is at least reduced relative to the first brake, in the case the first brake is actuated, such that, for example, the second end of the first flexible element may be moved, in comparison with the movability with the brake not being actuated, with increased force or cannot be moved at all.

The second haptic unit comprises a second brake, which is actuatable by means of a second control signal. The brake is provided for arrangement on the third body part, which is connected with the fourth body part via the second joint. The arrangement of the second brake, for example, may be made by means of a glove on or in which the second brake is arranged.

The second haptic unit further comprises a second flexible element extending between the third body part and the fourth body part and extending beyond the second joint. The second flexible element has a first end adapted for attachment to a third body part and a second end in engagement with the second brake. The engagement is such that, in the case the second brake is not actuated, the second end of the second flexible element is moveable relative to the second brake. Rather, the movability of the second end of the second flexible element is at least reduced relative to the second brake, in the case the second brake is actuated, such that, for example, the second end of the second flexible element may be moved, in comparison with the movability with the brake not being actuated, with increased force or cannot be moved at all.

In the haptic device, the first flexible element may have a longitudinal axis, wherein the first flexible element is moveable in directions of the longitudinal axis, in the case the first brake is not actuated.

Further, the second flexible element may have a longitudinal axis and may be moveable in directions of the longitudinal axis, in the case the second brake is not actuated.

Preferably, when the first flexible element has a longitudinal axis, the first flexible element is moveable in directions deviating from the longitudinal axis, in the case the first brake is actuated. Thus, for example, the first flexible element may not only be moved in a translational direction, but may be also rotated and/or pivoted relative to its longitudinal axis. This has the advantage that movements of the first and second body parts relative to one another are not or only slightly limited.

Preferably, when the second flexible element has a longitudinal axis, the second flexible element is moveable in directions deviating from the longitudinal axis, in the case the second brake is actuated. Thus, for example, the second flexible element can not only be moved in a translational direction, but also be rotated and/or pivoted relative to its longitudinal axis. This has the advantage that movements of the third and fourth body parts relative to one another are not or only slightly limited.

In the haptic device, the first end of the first flexible element may be pivotably attached with respect to the first body part, for example, by means of a corresponding connection with the material of a glove. Thus, possible movement limitations of the first and second body parts relative to one another may also be minimized.

The first end of the second flexible element may be pivotably attached, namely with respect to the second body part, for example, by means of a corresponding connection with the material of a glove. The first end of the second flexible element may also be connected to the first brake, preferably also pivotable. Thus, possible movement limitations of the first and second body parts relative to one another can also be minimized.

In the haptic device, the first end of the second flexible element may be pivotably attached with respect to the third body part, for example, by means of a corresponding connection with the material of a glove. Thus, possible movement limitations of the third and fourth body parts relative to one another may also be minimized.

In the haptic device, the first flexible element may comprise, at least in parts, a first braking surface, and the first brake may comprise a first controllably moveable brake element adapted to interact with the first braking surface in such way that movements of the first flexible element are at least limited.

The second flexible element may also comprise, at least in parts, a second braking surface, and the second brake may comprise a second controllably moveable brake element adapted to interact with the second braking surface in such way that movements of the second flexible element are at least limited.

By at least limiting the movements of a flexible element, it is particularly understood that the force required for movements of the flexible element is larger as compared to cases without interaction of the braking surface and the brake element, or that no movement of the flexible element is possible.

A braking surface may be provided in that a surface or side of the first flexible element comprises, preferably at least on the second end, a material texture having increased friction (for example by a coating) and/or is structured (e.g. serrated, provided with projections/recesses, with a groove extending in a longitudinal direction of the first flexible element, etc.).

A moveable brake element may comprise, for example, a surface that may be brought into contact with a braking surface, in order to interact with the braking surface in frictional or force-fitting manner, and/or may comprise a detent, gear and the like, as well as an element having a shape for engaging a recess or groove in the braking surface, which may controllably engage the structure of a braking surface.

A surface that may be brought into contact with a braking surface may act as a “brake shoe”, which at least increases forces required for movement of the flexible element by friction with the braking surface or completely prevents movement of the flexible element.

In the case of a detent used as a brake element, the detent may be moveable, e.g., to engage in a serration or projections/recesses of the braking surface such that movement of the flexible element is prevented, wherein the flexible element may be moved if the detent does not (any more) engage the serration or projections/recesses of the braking surface.

By means of a brake element in the form of a detent, it is also possible to enable the detent to engage a serration or projections/recesses such that the conditions, in which the flexible element cannot be moved, and those, in which the flexible element may be moved, alternate. In this way, it is possible to limit movements of the flexible element more or less.

In the case of a gear used as a brake element, movements/rotations of the gear may arise due to the engagement of the teeth of the gear and a serration or projections/recesses of a braking surface. In order to (more or less) limit movements of the flexible element or not at all, in other words, that different forces are required for movement of the flexible element, the gear may be braked correspondingly (e.g. by means of a friction-/force fit brake acting on a shaft supporting the gear)

In particular, it is provided that the first flexible element comprises, at least in parts, a structured surface and the first brake comprises a first brake element adapted to interact with the structured surface in frictional and/or force-fitting manner, and/or that the second flexible element comprises, at least in parts, a structured surface and that the second brake comprises a second braking device adapted to interact with the structured surface in frictional and/or force-fitting manner.

In the haptic device, the first brake may comprise a first actuator controllable by means of the first control signal and/or the second brake may comprise a second actuator controllable by means of the first control signal.

Preferably, such an actuator is adapted to selectively control movements of the respective brake element, in particular, to at least limit movements of the respective brake element and/or to actively move the respective brake element.

In particular, it is provided to controllably move the respective brake element by means of an actuator. Thus, for example, a piezoelectric actuator may be used as actuator in order to move a brake element in form of a surface or detent that may be brought into contact with a braking surface. Further, an arrangement that may be used as an actuator may move, by means of a controllable magnet (electromagnet) and a connection (e.g. rod) between the magnet and the corresponding brake element (e.g. in the case of a surface or detent that may be brought into contact with a braking surface), said brake element. Electric, hydraulic and/or pneumatic actuators may also be used as actuators, in order to controllably move the respective brake element and/or limit movements of the respective brake element and/or prevent or allow them.

Further, it is provided that an actuator may be formed as a brake, in order to actively move the corresponding brake element. This allows not only to, at least, limit movements of a corresponding flexible element, but also to move the flexible element, in order to allow a user to sense forces generated by the haptic device which are not sensable in response to movements of body parts.

In the haptic device, the first haptic unit may comprise a first sensor device adapted to detect positions and/or movements of the first body part and the second body part relative to one another and to output corresponding first sensor signals, and/or the second haptic unit may comprise a second sensor device adapted to detect positions and/or movements of the third body part and the fourth body part relative to one another and to output corresponding second sensor signals.

By means of such a sensor device, positions and/or movements of the associated two body parts relative to one another may be determined. The respective sensor signals may be used to control the corresponding brake, depending on the determined positions and/or movements. In such embodiments, the control signals for the brakes may be generated by the haptic device itself, e.g., in the case the haptic device receives information of an associated system for which positions and/or movements of the body parts a force feedback is to be generated for the user.

The respective sensor signals may be provided to a system (e.g. system for robotic control/-simulation, device-environment, video game, telemanipulation system etc) co-operating with the haptic device, in order to interact with said system. In such cases, the system co-operating with the haptic device may generate the control signals for the brakes and provide them to the haptic device for brake control.

Preferably, the haptic device comprises a control adapted to at least partially generate at least one of the first control signal for controlling the first brake and the second control signal for controlling the second brake, in particular, in the case the haptic device receives information from an associated system for positions and/or movements of the body parts a force feedback is to be generated for the user.

In addition or alternatively it is provided that the control is adapted to obtain an external control signal for at least one of the control signals for the brake and to generate, on its basis, the corresponding one of the first and second control signal for brake control, in particular if the control signal or signals are provided by a system co-operating with the haptic device.

Preferably, the control comprises an interface for data exchange with a computer system. The interface may be adapted for wired and/or wireless communication.

Further, the present invention provides a haptic arrangement comprising a garment and at least one haptic device according to one of the preceding claims, wherein the at least one haptic device is arranged on and/or in the garment in such way that the haptic device is associated with at least two joints of a user arranged in series, when the user is wearing the garment.

The above statements regarding joints and body parts arranged in series also apply here.

Preferably, the garment is provided as a glove, an arm warmer (a garment that may cover the arm of a person between the shoulder and the hand), a leg warmer (a garment that may cover the leg of a person between the hip and the foot), garments that may cover the upper body and/or the lower body of a person (e.g. pants and or t-shirt-like clothing), etc.

For illustration of an haptic arrangement with a garment, reference is made to a glove, in order to generate force feedback for a user wearing the glove for at least one finger, with respect to its distal- and proximal-interphalangeal joints and its metacarpo-phalangeal joints. Therefore, the first haptic unit may be arranged on the glove in such way that, when the glove is worn, the first brake comes to rest on the first finger phalanx and the first end of the first flexible element lies on, or is attached to the region of the glove provided for the third phalanx. This allows to generate force feedback for a user wearing the glove with respect to the distal- and proximal-interphalangeal joints. The second haptic unit may be arranged on the glove in such way that, when the glove is worn, the second brake comes to rest on the back of the hand (e.g. in proximity of the metacarpo-phalangeal joint) and the first end of the second flexible element lies on, or is attached to the region of the glove provided for the first phalanx or is attached to the first brake of the first haptic unit. This allows to generate force feedback for a user wearing the glove with respect to the metacarpo-phalangeal joint. With respect to all three finger joints, in order to generate force feedback for each joint individually, the glove may have a further, third haptic unit, in such way that a respective haptic unit is associated with each of the distal- and proximal-interphalangeal- and metacarpo-phalangeal joints.

The above observations accordingly apply to other body parts and joints and garments suitable for that, respectively.

Furthermore, the present invention provides a control method for a haptic device for a first joint connecting two body parts and a second joint connecting two body parts, arranged in series with the first joint.

Apart from the following observations, the above observations concerning the inventive haptic devices apply accordingly to the inventive control method.

Preferably, the control method for controlling of the inventive haptic device is provided according to one of the above embodiments.

In the method according to the invention, a first brake of a first haptic unit, wherein the first brake is arranged on a first body part that is connected to a second body part via the first joint and wherein the first brake may come into engagement with a first flexible element connected to the second body part in order to at least limit the movability of the first flexible element, is actuated by means of a first control signal, in the case a movement of the first body part and the second body part relative to one another should be at least limited by means of the first joint.

Further, in the method according to the invention, a second brake of a second haptic unit wherein the second brake is arranged on a third body part that is connected to a fourth body part via the second joint and wherein the second brake may come into engagement with a second flexible element connected to the fourth body part in order to at least limit the movement of the second flexible element, is actuated by means of a second control signal, in the case a movement of the third body part and the fourth body part relative to one another should be at least limited by means of the second joint.

Further, it is provided that the control method according to the invention detects positions and/or movements of the first body part and the second body part relative to one another by means of a first sensor device of the first haptic unit and positions and/or movements of the third body part and the fourth body part relative to one another by means of a second sensor device of the second haptic unit.

Preferably, the first brake is actuated in dependence of positions and/or movements detected by means of the first sensor device and/or the second brake is actuated in dependence of positions and/or movements detected by means of the second sensor device.

In any cases, the actuation of a brake may occur also in dependence of information received in form of external control signals.

In particular, it is provided to generate the first control signal with respect to a first reference value in dependence of positions and/or movements detected by means of the first sensor device, and/or the to generate the second control signal with respect to a second reference value in dependence of positions and/or movements detected by means of the second sensor device.

Reference values may for example include values, data etc. e.g. received from an external system (e.g. system for robotic control/-simulation, device-environment, video game, telemanipulation system), indicating positions in space, material properties, object boundaries and other information, according to which a force feedback is to be generated.

For example, a reference value may indicate that at least one of the body parts is not to be moved or only limitedly moved, when it takes or has a certain position. A reference value may indicate that a force feedback, which is to be generated with respect to at least one body part, conveys the feeling of contacting a material with a certain material property (soft, hard, rubbery, rough, smooth, etc.). A reference value may indicate that a force feedback, which is to be generated with respect to at least one body part, conveys the feeling of contacting an object moving and/or changing its shape (e.g. a moving lever, an expanding balloon, elastic material during compression/release). A reference value may indicate that a force feedback, which is to be generated with respect to at least one body part, conveys the feeling of contacting an object (e.g. grabbing and/or moving an object).

Further, the present invention provides a computer program product stored on a computer readable medium and that executes the steps of the inventive method according to one of its embodiments, using program code executed by means of a computer.

### BRIEF DESCRIPTION OF THE DRAWINGS

In the following, preferred embodiments of the present invention are explained with reference to the accompanying drawings, which show:

FIGS. 1 and 2 a schematic illustration of a haptic arrangement of an embodiment according to the invention as a data glove,

FIG. 3 a schematic illustration of a haptic arrangement for use with the proximal- and distal-interphalangeal joints according to the invention,

FIG. 4 a schematic illustration of a haptic arrangement for use with the metacarpo- and distal-interphalangeal joints according to the invention,

FIG. 5 a schematic illustration of two haptic units of a haptic device according to the invention for use with the proximal- and distal-interphalangeal joints,

FIG. 6 a schematic illustration of an embodiment of a haptic unit of FIG. 5,

FIG. 7 different embodiments of flexible elements for a haptic unit of a haptic device according to the invention,

FIG. 8 an embodiment for actuating a brake element;

FIG. 9a und 9b a further embodiment for actuating a brake element,

FIG. 10 a schematic illustration of an embodiment for force feedback with respect to the elbow joint according to the invention, and

FIG. 11 und 12 drawings for illustration of possible applications of the haptic devices or haptic arrangements according to the invention.

### DESCRIPTION OF PREFERRED EMBODIMENTS

For purposes of illustration, reference will be made in the following to an embodiment of a haptic device according to the present invention in the form of a data glove, which generates force feedback for a user wearing the glove with respect to its fingers. Further, the user may also use the data glove as input device, e.g. for a computer system, wherein positions and/or movements of fingers of the user are detected and corresponding signals are provided.

In some drawings, the material of the part of the haptic device forming the actual glove is omitted for simplicity. Shown elements of the haptic device may be arranged on the glove material and/or be integrated therein.

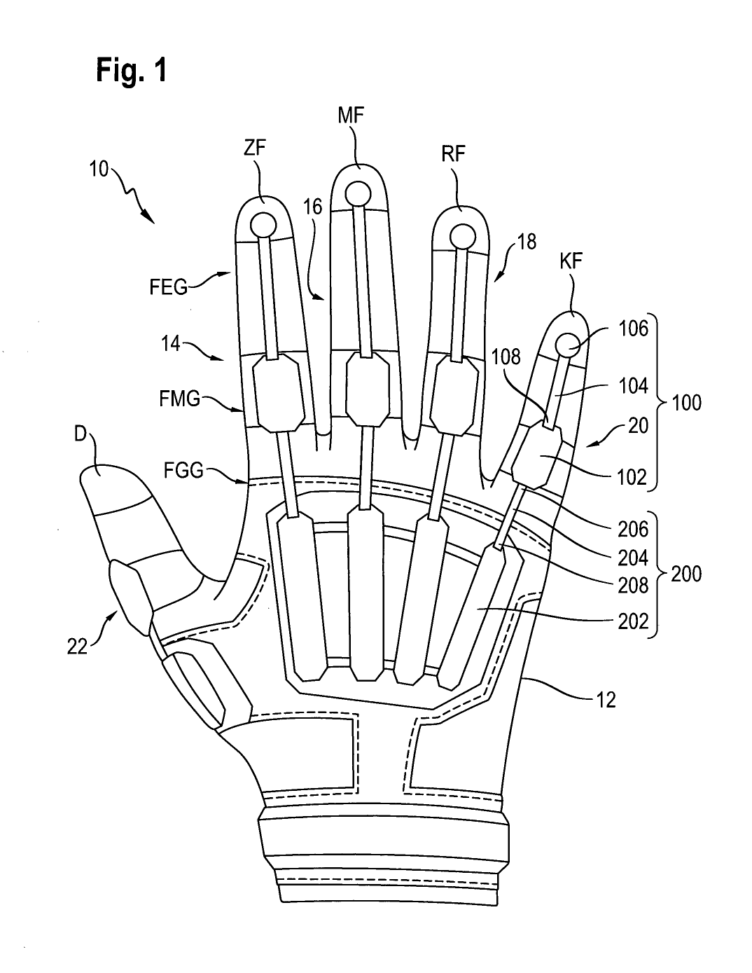

FIGS. 1 and 2 show a haptic arrangement 10 according to the present invention in form of a data glove. The haptic arrangement 10 includes a glove 12 comprising, for example, a textile material. On the outer side of the glove 12 (or also at least partially integrated in its material), a haptic device 14 is arranged for an index finger ZF, a haptic device 16 is arranged for a middle finger MF, a haptic device 18 is arranged for a ring finger RF, a haptic device 20 is arranged for a little finger KF and a haptic device 22 is arranged for a thumb D.

Each of the haptic devices 14, 16, 18, and 20 has a first haptic unit 100 and a second haptic unit 200, which are explained in greater detail below. [Note: In FIG. 1, only the first and second haptic unit 100 and 200 are labeled for the small finger KF, for the sake of clarity].

According to the embodiment of FIG. 1, the second haptic units 200 are embodied as components being separated from each other. According to the embodiment of FIG. 2, the second haptic units 200 are embodied in a common housing GEH.

According to FIGS. 1 and 2, the haptic device 22 has a first haptic unit 100 and a second haptic unit for the thumb D. In further embodiments, also only one first haptic unit 100 may be used for a thumb.

According to FIGS. 1 and 2, the haptic devices 14, 16, 18 and 20 are embodied or arranged, in order to generate force feedback for a user wearing the glove with respect to the respective finger, with respect to its distal- and proximal-interphalangeal joints as well as its metacarpo-phalangeal joints.

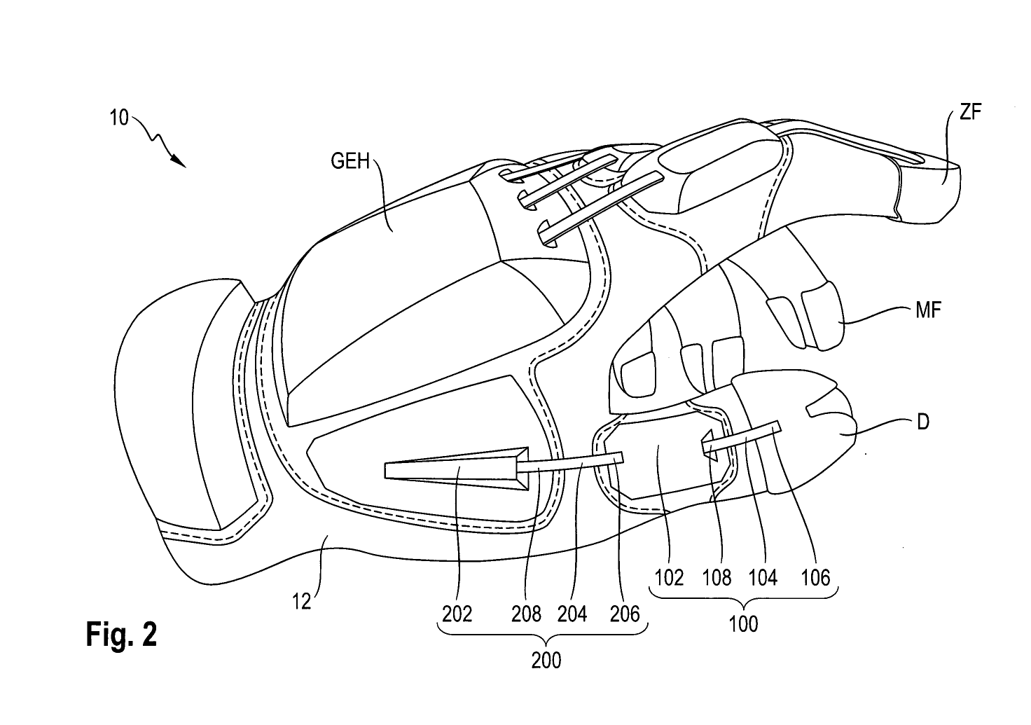

The arrangement of components provided to this end, which are described in greater detail below, of the first haptic devices 100 and the second haptic devices 200 is schematically illustrated in FIG. 3.

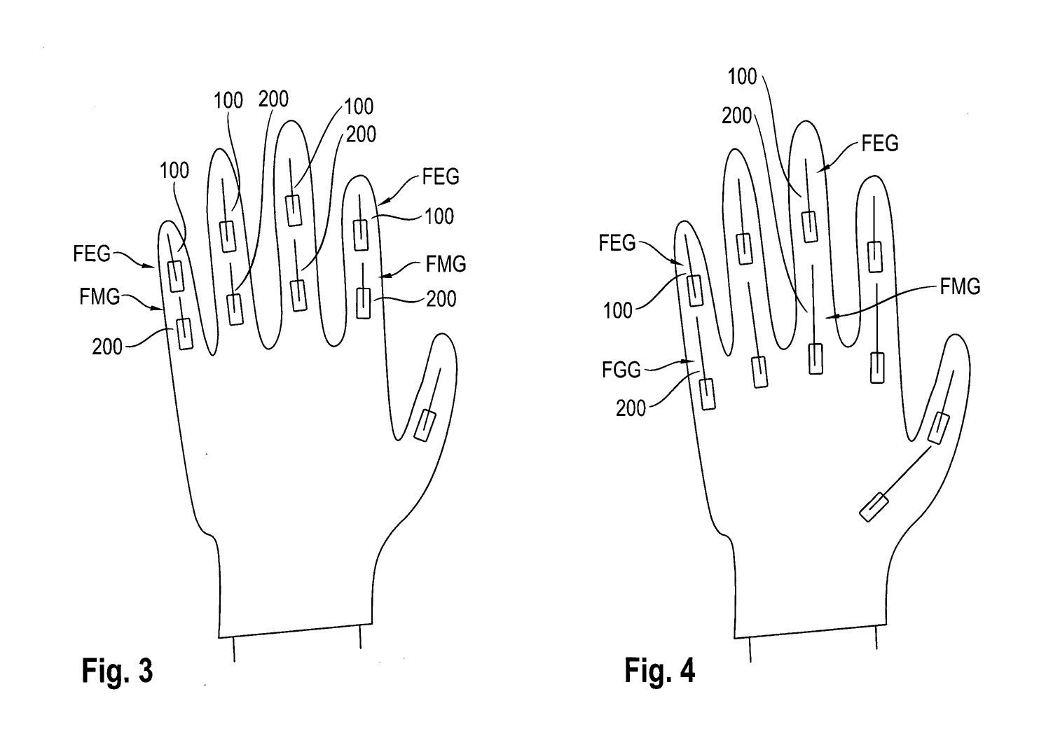

FIG. 4 schematically illustrates an arrangement of components of the first haptic devices 100 and the second haptic devices 200 for a haptic arrangement, in order to generate force feedback for a user wearing the glove with respect to fingers of a hand, each with respect to its distal interphalangeal joint and its proximal interphalangeal joint.

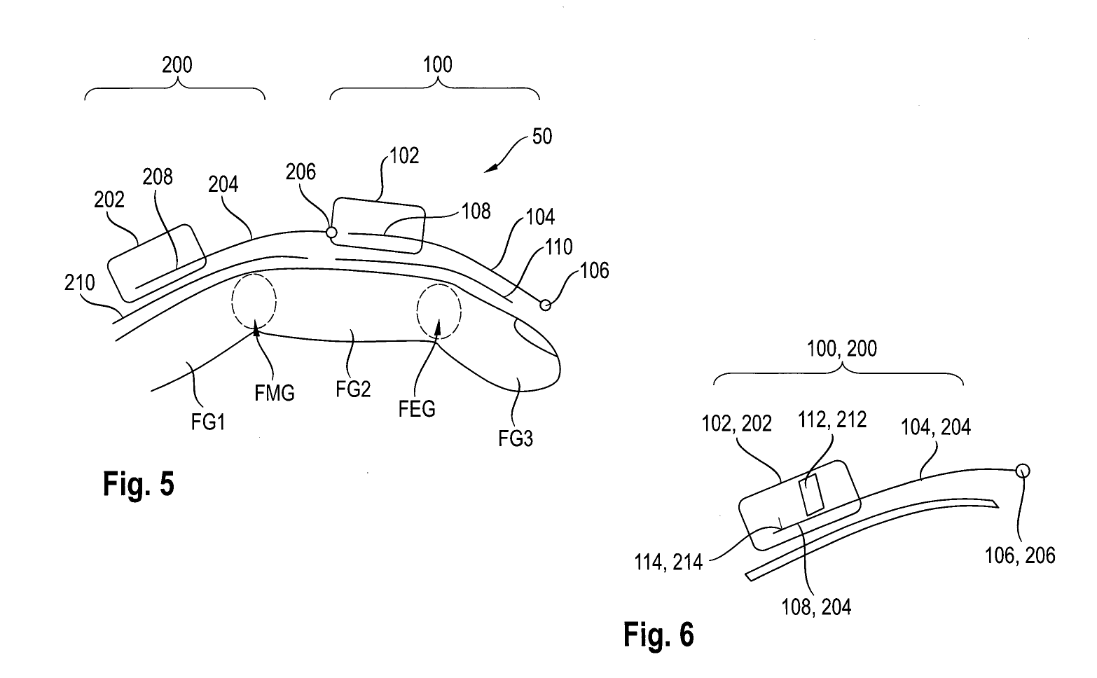

For explanation of a haptic device according to the invention, reference is now made to FIG. 5, for which the arrangement according to FIG. 3 was taken as a basis. The embodiments in this regard also apply for e.g. the arrangements of FIGS. 1, 2 and 4.

FIG. 5 shows parts of a haptic device 50 for a (any) finger F. The haptic device 50 generates force feedback for a user with respect to a distal interphalangeal joint FEG and with respect to a proximal interphalangeal joint FMG.

The distal interphalangeal joint FEG and the proximal interphalangeal joint FMG are arranged in series. The distal interphalangeal joint FEG connects the third finger phalanx FG3 as a first body part and the second finger phalanx FG2 as a second body part. The proximal interphalangeal joint FMG connects the second finger phalanx FG2 as third body part and the first finger phalanx FG1, as a fourth body part.

The haptic device 50 comprises a first haptic unit 100 with a first brake 102 and a first flexible element 104. The first flexible element 104 has a first end 106 and a second end 108. Further, the first haptic unit 100 comprises a first sensor device 110.

The first end 106 of the first flexible element 104 is attached on, or in the glove material in such way that, when worn, the first end 106 of the first flexible element 104 lies on or is attached to the region of the glove provided for the third phalanx. The first brake 102 is arranged in such way that it comes to rest on the second phalanx FG2. This allows to generate force feedback for a user wearing the glove with respect to the distal interphalangeal joint FEG.

The haptic device 50 comprises a second haptic unit 200 with a second brake 202 and a second flexible element 204. The second flexible element 204 has a first end 206 and a second end 208. Further, the second haptic unit 200 comprises a second sensor device 210.

The first end 206 of the second flexible element 204 is attached on or in the glove material in such way that, when worn, the first end 206 of the second flexible element 204 lies on, or is attached to the region of the glove provided for the first phalanx, or, as shown, is attached to the first brake 102 of the first haptic unit 100. The second brake 202 is arranged in such way that it comes to rest on the first phalanx FG1. This allows to generate force feedback for a user wearing the glove with respect to the proximal interphalangeal joint FMG.

The sensor devices 110 and 210 shown in FIG. 5 are formed in such way that the first sensor device 110 is extending over the distal interphalangeal joint FEG between the second and third phalanxes FG2 and FG3 and the second sensor device 210 is extending over the proximal interphalangeal joint FMG between the first and second phalanxes FG1 and FG2.

Such elongated sensor devices may, for example, operate in the manner of an electrical and/or optical strain gauge. Further, sensor devices may be used to detect bends of electrical and/or optical conductors caused by finger movements.

In contrast thereto, the components of the embodiments of FIGS. 1 and 2 of the first haptic devices 100 and the second haptic devices 200 are arranged for a haptic arrangement in order to generate force feedback for a user wearing the glove with respect to fingers of a hand, each with respect to its distal- and proximal-interphalangeal joints, FEG and FMG, as well as its metacarpo-phalangeal joint FGG. This will be explained in the following with reference to the haptic device 20 for the small finger KF.

The haptic device 20 comprises a first haptic unit 100 with a first brake 102 and a first flexible element 104. The first flexible element 104 has a first end 106 and a second end 108.

The first end 106 of the first flexible element 104 is attached on or in the glove material in such way that, when worn, the first end 206 of the first flexible element 104 lies on or is attached to the region of the glove provided for the third phalanx FG3. The first brake 102 is arranged in such way that it comes to rest on the first phalanx FG1. This allows to generate force feedback for a user wearing the glove with respect to the distal- and proximal-interphalangeal joints FEG and FMG.

The haptic device 20 comprises a second haptic unit 200 with a second brake 202 and a second flexible element 204. The second flexible element 204 has a first end 206 and a second end 208.

The first end 206 of the second flexible element 204 is attached on or in the glove material in such way that, when worn, the first end 206 of the second flexible element 204 lies on or is attacked to the region of the glove provided for the second phalanx FG2, or, as shown, is attached on the second brake 202 of the first haptic unit 100. The second brake 202 is arranged in such way that it comes to rest on the back of the hand (e.g. in proximity of the metacarpo-phalangeal joint). This allows to generate force feedback for a user wearing the glove with respect to the metacarpo-phalangeal joint FGG.

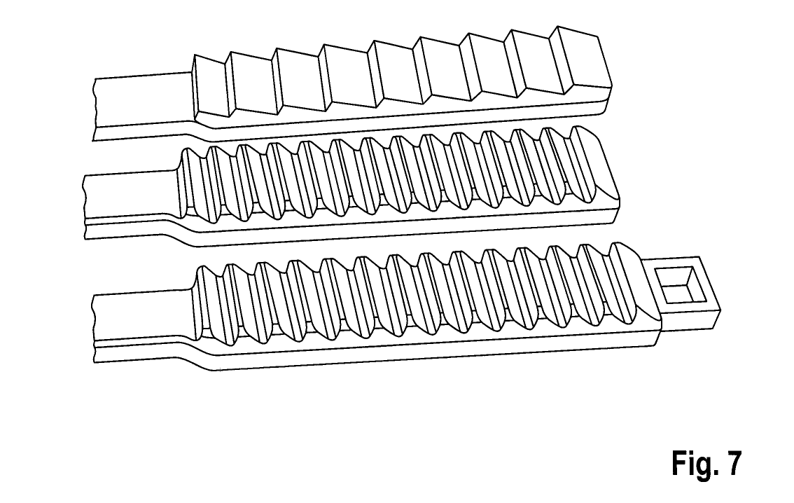

FIG. 6 illustrates an embodiment of how the movability of a second end of the flexible element relative to the brake may be at least reduced by means of a brake when the brake is actuated. FIG. 6 refers to the first and second haptic devices together.

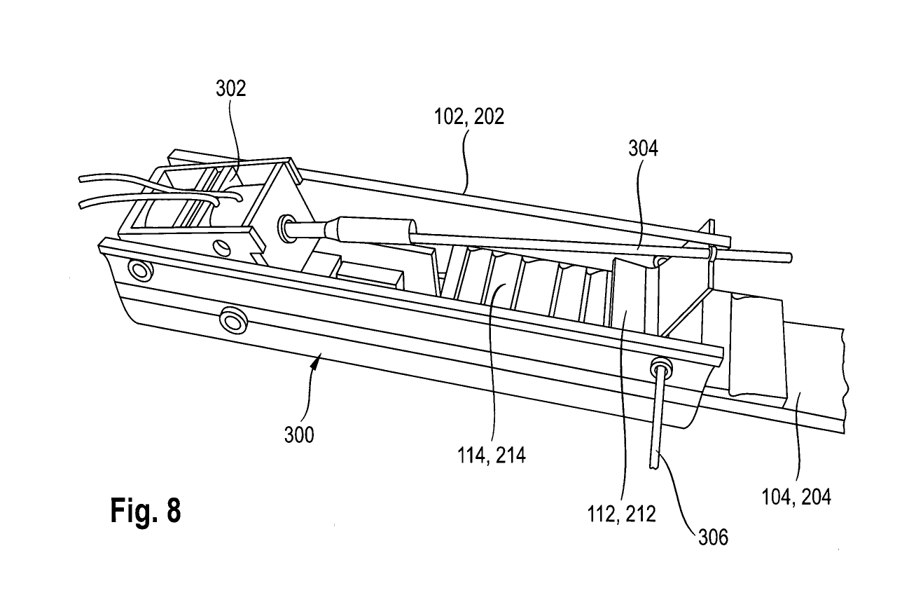

The brake 102/202 has a controllable brake element 112/212 formed as a moveable handle or detent. The flexible element 104/204 is provided at least in a region with a braking surface 114/214. Possible braking surfaces for the brake element 112/212 are shown in FIG. 7.

If no force feedback is to be generated, the brake element 112/212 is or will be positioned in such way that it does not interact with the braking surface 114/214 and the flexible element 104/204 may move relative to the brake. Such a position of the brake element 112/212 may be achieved for example, in the case the brake element 112/212 is pivotable and may be pivoted by means of an actuator into this position, not resulting into engagement with the braking surface 114/214.

If force feedback is to be generated, the brake element 112/212 is or will be positioned in such way that it does interact with the braking surface 114/214 and the flexible element 104/204 may not, or only limitedly move relative to the brake. Such a position of the brake element 112/212 may be achieved for example, if the brake element 112/212 is pivotable and may be pivoted by means of an actuator into this position, resulting into engagement with the braking surface 114/214.

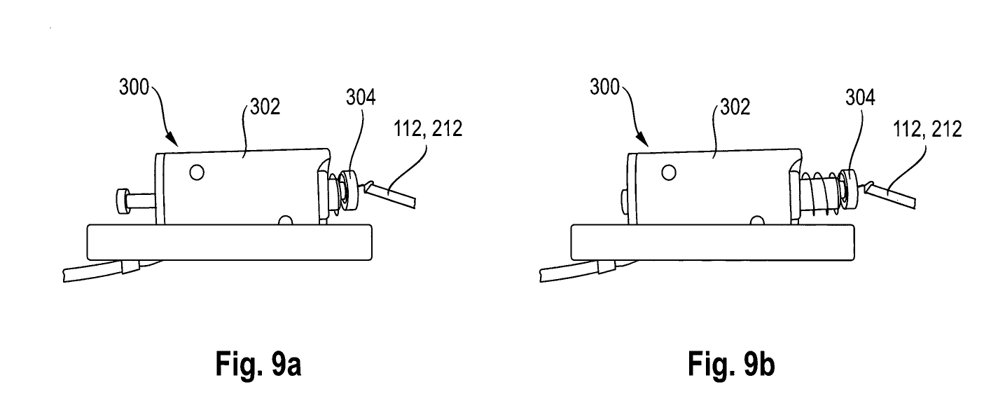

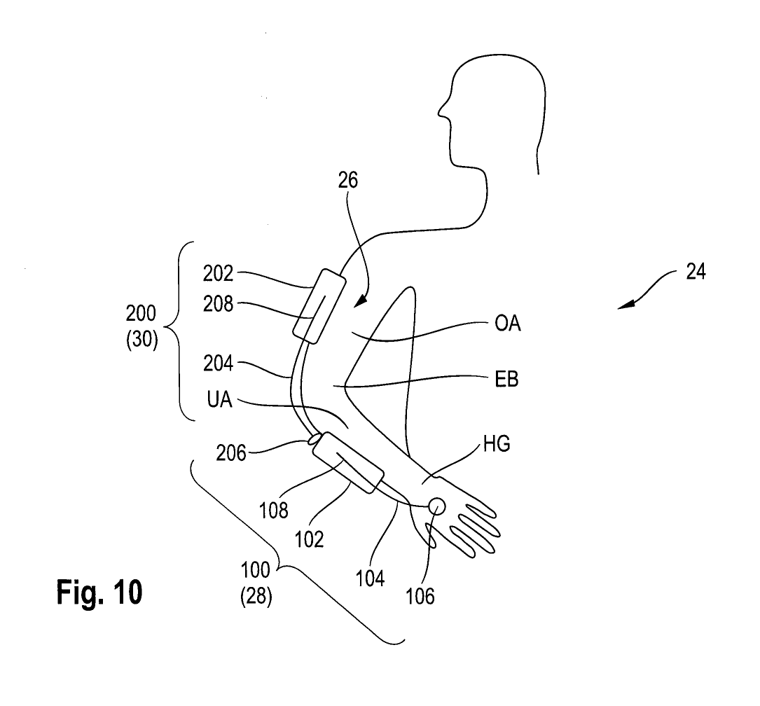

Movements of the brake element 112/212 may be achieved, as shown in FIG. 8 and FIGS. 9a and 9b, by means of a magnet-operated actuator. According to the drawings, such an actuator 300 comprises, for example, a controllable electromagnet 302 connected to a brake element 112/212 via a stiff, rigid connection 304. The brake element 112/212 is rotably supported about a shaft 306. In FIG. 8, the brake element is being in a position not resulting into engagement with the breaking surface 114/214; this is also the case in FIG. 9a. In contrast thereto, the brake element 112/212 in FIG. 9b, is in a position resulting into engagement with the braking surface 114/214. The brake element 112/212 is pivoted from one of these positions into the other and vice versa, in that the brake element 112/212 is correspondingly moved by means of an electromagnet 302 and the connection 304, in order to allow movements of the flexible element 104/204 or, according to such embodiments, to prevent them.

In the case a brake element in the form of a gear is used instead of one in the form of a detent, the movability of a flexible element may, as explained above, be influenced stepwisely or substantially stepless. By means of a drive connected to such a brake element, it may be achieved to move a flexible element by means of the brake element.

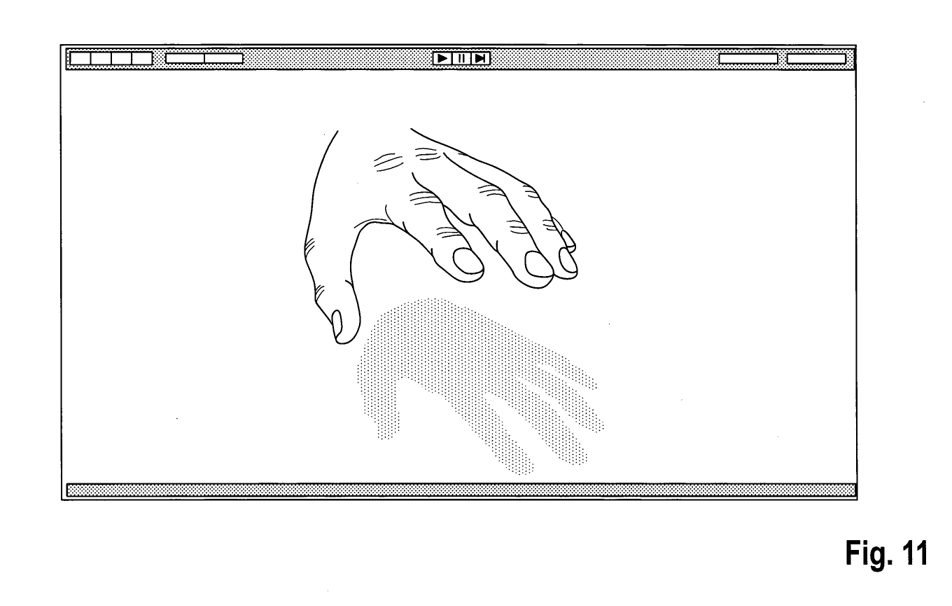

FIG. 10 schematically shows a haptic arrangement 24 in the form of data arm warmer, which may also be referred to as “data glove on an arm”. The haptic arrangement 24 has an arm warmer 26, comprising for example a textile material. The haptic arrangement 24 has a first haptic device 100 in the form of a haptic device 28 for a wrist HG and a second haptic device 200 in the form of a haptic device 30 for an elbow EB. The haptic devices 28 and 30 may be arranged on the outer side of the arm warmer 26 and/or also partially integrated in its material.

In the haptic device 28, a first end 106 of a flexible element 104 is attached to the back of the hand HR and a first brake 102 is attached to the forearm UA. In the haptic device 30, a first end 206 of a flexible element 204 is attached to the forearm, or to the first brake 102 and a second brake 102 is attached to the upper arm OA.

According to FIG. 10, the haptic devices 28 and 30 are embodied or arranged to generate force feedback for a user wearing the arm warmer 26 with respect to the wrist joint and the elbow joint.

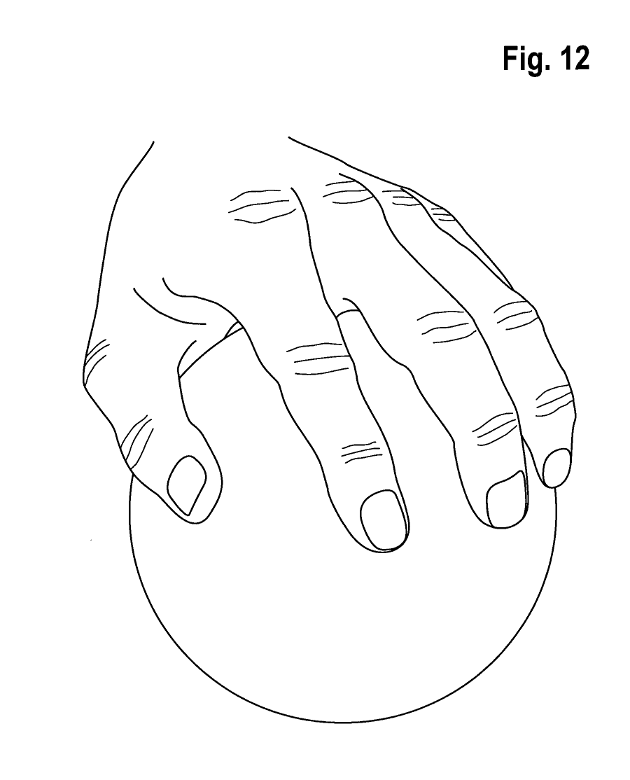

FIGS. 11 and 12 illustrate a possible application of a haptic arrangement according to the invention in the form of a data glove, such as that of FIGS. 1 and 2. FIG. 11 shows a virtual hand, visualized for example by means of a monitor, whose movements are controllable by means of the haptic arrangement (data glove). Positions and movements of a hand of a user of the haptic arrangement, detected by sensor devices (see sensor devices 110 and 210) of the haptic arrangement, are translated, and e.g. visualized, in corresponding positions and movements of the virtual hand.

In the case, as illustrated in FIG. 12, the virtual hand controlled by the user virtually contacts a virtual object (sphere), a corresponding force feedback for the user is generated by the haptic arrangement. In the example shown in FIG. 12, all fingers of the virtual hand contact the virtual object, for which it is assumed in a simplified first step to be not elastic. The haptic arrangement is intended to convey to the user the sensation that he has, if he actually contacts such an object with his hand. For this purpose, the brakes are activated for the position of the hand of the user, in which the virtual hand virtually contacts the virtual object (sphere), in order to allow no movements of the elastic elements. This results in that the user not being able to move his finger further in the directions, in which they have been moved previously; such as it is the case when contacting/gripping a real object.

In case of alternatively assuming that the virtual object has elastic properties, the haptic arrangement is intended to convey to the user the sensation that he grabs such an elastic object. The brakes are actuated in such way that the movements of the fingers of the user are impeded by increasing the resistance to movement, but are not completely prevented. A virtual object with elastic properties generates restoring forces in the compressed state. This perception may also be conveyed to the user. The actuators of the brakes may actively move the corresponding brake elements, in order to make the generated restoring forces sensable for a user.

| Reference sign | Description |
|---|---|
| 10 | haptic arrangement (data glove) |
| 12 | glove |
| 14 | haptic device for an index finger |
| 16 | haptic device for a middle finger |
| 18 | haptic device for a ring finger |
| 20 | haptic device for a small finger |
| 22 | haptic device for a thumb |
| 24 | haptic arrangement (data arm warmer) |
| 26 | arm warmer |
| 28 | haptic device for a wrist joint |
| 30 | haptic device for an elbow |
| 50 | haptic device (general representation) |
| 100 | first haptic device |
| 102 | first brake |
| 104 | first flexible element |
| 106 | first end of the first flexible element |
| 108 | second end of the first flexible element |
| 110 | first sensor device |
| 112 | brake element of the first brake (handle or |
| | detent) |
| 114 | braking surface of the first flexible element |
| 200 | second haptic device |
| 202 | second brake |
| 204 | second flexible element |
| 206 | first end of the second flexible element |
| 208 | second end of the second flexible element |
| 210 | second sensor device |
| 212 | brake element of the second brake (handle or |
| | detent) |
| 214 | braking surface of the second flexible element |
| 300 | actuator |
| 302 | electromagnet |
| 304 | connection electromagnet-brake element |
| ZF | index finger |
| MF | middle finger |
| RF | ring finger |
| KF | small finger |
| D | thumb |
| FGG | metacarpo-phalangeal joint |
| FMG | proximal interphalangeal joint |
| FEG | distal interphalangeal joint |
| F | finger |
| FG1 | first phalanx |
| FG2 | second phalanx |
| FG3 | third phalanx |
| GEH | housing for various haptic devices |
| HG | wrist joint |
| EB | elbow joint |
| HR | back of the hand |
| UA | forearm |
| OA | upper arm |

1. A haptic device for a first joint connecting two body parts and a second joint, arranged in series with the first joint and connecting two body parts, comprising:
a first haptic unit comprising
a first brake, which is actuatable by means of a first control signal, for arrangement on a first body part connected to a second body part via the first joint,
a first flexible element, which extends between the first body part and the second body part over the first joint, with a first end for attachment to the second body part and a second end in engagement with the first brake, wherein, in the case the first brake is not actuated, the second end of the first flexible element is moveable relative to the same, and wherein the movability of the second end of the first flexible element is at least reduced relative to the first brake upon actuation of the first brake, and
a second haptic unit comprising
a second brake, which is actuatable by means of a second control signal, for arrangement on a third body part connected to a fourth body part via the second joint,
a second flexible element, which extends between the third body part and the fourth body part over the second joint, with a first end for attachment to the fourth body part and a second end in engagement with the second brake, wherein, in the case the second brake not being actuated, the second end of the second flexible element is moveable relative to the same, and wherein the movability of the second end of the second flexible element is at least reduced relative to the second brake upon actuation of the second brake.

2. The haptic device according to claim 1, wherein
the first flexible element has a longitudinal axis and is movable in directions of the longitudinal axis, in the case the first brake is not actuated, and/or
the second flexible element has a longitudinal axis and is movable in directions of the longitudinal axis, in the case the second brake is not actuated.

3. The haptic device according to claim 1, wherein
the first flexible element has a longitudinal axis and is movable in directions of the longitudinal axis, hi the case the first brake is not actuated, and/or, in the case the first brake is actuated, is movable in directions deviating therefrom, and/or
the second flexible element has a longitudinal axis and is movable in directions of the longitudinal axis, in the case the second brake is not actuated, and/or, in the case the first brake is actuated, is movable in directions deviating therefrom, and/or

4. The haptic device according to claim 1, wherein
the first end of the first flexible element is pivotably attached, and/or
the first end of the second flexible element is pivotably attached or connected to the first brake, preferably pivotable.

5. The haptic device according to claim 1, wherein
the first flexible element at least partially comprises a first braking surface and the first brake comprises a first controllably moveable brake element adapted to interact with the first braking surface in such way that movements of the first flexible element are at least limited, and/or
the second flexible element at least partially comprises a second braking surface and the second brake comprises a second controllably moveable brake element adapted to interact with the second braking surface in such way that movements of the second flexible element are at least limited.

6. The haptic device according to claim 1, wherein
the first brake comprises a first actuator controllable by means of the first control signal, and/or
the second brake comprises a second actuator controllable by means of the first control signal.

7. The haptic device according to claim 1, wherein
the first controllable actuator is adapted to selectively control movements of the first brake element, and/or
the second controllable actuator is adapted to selectively control movements of the second brake element.

8. The haptic device according to claim 1, wherein
the first haptic unit comprises a first sensor device adapted to detect positions and/or movements of the first body part and the second body part relative to one another and to output corresponding first sensor signals, and/or
the second haptic unit comprises a second sensor device adapted to detect positions and/or movements of the third body part and the fourth body part relative to one another and to output corresponding second sensor signals.

9. The haptic device according to claim 1, further comprising a control adapted to
generate the first control signal for controlling the first brake and/or the second control signal for controlling the second brake, and/or
receive a first external control signal and to generate, on its basis, the first control signal and/or to receive a second external control signal and to generate, on its basis, the second control signal.

10. The haptic device according to claim 1, wherein the control comprises an interface for data exchange with a computer system.

11. A haptic arrangement comprising
a garment; and
at least one haptic device for a first joint connecting two body parts and a second joint, arranged in series with the first joint and connecting two body parts, the at least one haptic device comprising:
a first haptic unit comprising
a first brake, which is actuatable by means of a first control signal, for arrangement on a first body part connected to a second body part via the first joint,
a first flexible element, which extends between the first body part and the second body art over the first joint, with a first end for attachment to the second body part and a second end in engagement with the first brake, wherein, in the case the first brake is not actuated, the second end of the first flexible element is moveable relative to the same, and wherein the movability of the second end of the first flexible element is at least reduced relative to the first brake upon actuation of the first brake, and
a second haptic unit comprising
a second brake, which is actuatable by means of a second control signal, for arrangement on a third body part connected to a fourth body part via the second joint,
a second flexible element which extends between the third body art and the fourth body part over the second joint, with a first end for attachment to the fourth body part and a second end in engagement with the second brake, wherein, in the case the second brake not being actuated, the second end of the second flexible element is moveable relative to the same, and wherein the movability of the second end of the second flexible element is at least reduced relative to the second brake upon actuation of the second brake,
wherein the at least one haptic device is arranged on and/or in the garment in such way that the haptic device is associated with at least to joints of a user arranged in series, when the user is wearing the garment.

12. A control method for a haptic device for a first joint, connecting two body parts and a second joint arranged in series with the first joint and connecting two body parts, wherein the method comprises:
actuating a first brake of a first haptic unit, wherein the first brake is arranged on a first body part connected to a second body part via the first joint and the first brake can come into engagement with a first flexible element connected to the second body part, in order to at least limit the movability of the first flexible element by means of a first control signal, in the case a movement of the first body part and the second body part relative to one another is to be at least limited by means of the second joint, and
actuating a second brake of a second haptic unit, wherein the second brake is arranged on a third body part that is connected to a fourth body part via the second joint and the second brake can come into engagement with the second flexible element connected to the fourth body part, in order to at least limit the movability of the second flexible element by means of a second control signal, in the case a movement of the third body part and the fourth body part relative to one another is to be at least limited by means of the second joint.

13. The control method according to the claim 12, further comprising:
detecting of positions and/or movements of the first body part and the second body part relative to one another by means of a first sensor device of the first haptic unit, and/or
detecting of positions and/or movements of the third body part and the fourth body part relative to one another by means of a second sensor device of the second haptic unit.

14. The control method according to claim 13, wherein:
the actuation of the first brake occurs in dependence of the positions and/or movements, detected by means of the first sensor device, and/or
the actuation of the second brake occurs in dependence of the positions and/or movements, detected by means of the second sensor device.

15. The control method according to claim 14, wherein:
the first control signal is generated with respect to a first reference value in dependence of positions and/or movements detected by means of the first sensor device, and/or
the second control signal is generated with respect to a second reference value in dependence of positions and/or movements detected by means of the second sensor device.

16. A non-transitory computer readable medium, which when executed by a computer, performs a control method for a haptic device for a first joint, connecting two body parts and a second joint arranged in series with the first joint and connecting two body parts, the method comprising:
actuating a first brae of a first haptic unit wherein the first brake is arranged on a first body part connected to a second body part via the first joint and the first brake can come into engagement with a first flexible element connected to the second body part, in order to at least limit the movability of the first flexible element by means of a first control signal, in the case a movement of the first body part and the second body part relative to one another is to be at least limited by means of the second joint, and
actuating a second brake of a second haptic unit, wherein the second brake is arranged on a third body part that is connected to a fourth body part via the second joint and the second brake can come into engagement with the second flexible element connected to the fourth body part, in order to at least limit the movability of the second flexible element by means of a second control signal, in the case a movement of the third body part and the fourth body part relative to one another is to be at least limited by means of the second joint.
